(19) United States
(12) Patent Application Publication
(10) Pub. No.: US 2025/0233527 A1
(43) Pub. Date: Jul. 17, 2025

(54) POWER CONVERSION DEVICE AND STORAGE MEDIUM

(71) Applicant: DENSO CORPORATION, Kariya-city (JP)

(72) Inventors: Naoto KOBAYASHI, Nisshin-shi (JP); Kenji OCHI, Kariya-shi (JP); Kwan Ryul KIM, Kariya-shi (JP)

(73) Assignee: DENSO CORPORATION, Kariya-city (JP)

(21) Appl. No.: 19/096,791

(22) Filed: Apr. 1, 2025

Related U.S. Application Data
(63) Continuation of application No. PCT/JP2023/036598, filed on Oct. 6, 2023.

(30) Foreign Application Priority Data
Oct. 31, 2022 (JP) 2022-175108

(51) Int. Cl. H02M 7/217; H02M 1/00; H02M 7/00

(52) U.S. Cl. CPC H02M 7/2173; H02M 1/0083; H02M 7/003

(57) ABSTRACT

A power conversion device includes: first upper arm switch, a first lower arm switch, a second upper arm switch, a second lower arm switch, a third upper arm switch, a third lower arm switch, an upper arm rectifier, a lower arm rectifier, first to third inductor, a connection line, a single-phase charge switch installed in the connection line, first to third capacitors, a connection switch, and a control unit. When the control unit determines that the single-phase AC power source is connected to the first AC terminal and the fourth AC terminal, the control unit closes the single-phase charge switch and opens the connection switch, and, for converting power between the first AC terminal and the fourth AC terminal and the high voltage DC terminal and the low voltage DC terminal, performs switching control of the first upper arm switch and the first lower arm switch.

### CROSS-REFERENCE TO RELATED APPLICATIONS

The present application is a continuation application of International Application No. PCT/JP2023/036598, filed on Oct. 6, 2023, which claims priority to Japanese Application No. 2022-175108 filed on Oct. 31, 2022. The contents of these applications are incorporated herein by reference in their entirety.

### BACKGROUND

### 1. Technical Field

This disclosure relates to a power conversion device and a storage medium.

### 2. Related Art

JP6636219B1 discloses a power conversion device that can be connected to a 3-phase ac power source. The power conversion device has series-connected elements for 3-phase, each of the series-connected elements including an upper arm switch and a lower arm switch. A high voltage terminal of each of the upper arm switches is electrically connected to a high voltage DC terminal, and a low voltage terminal of each of the lower arm switches is electrically connected to a low voltage DC terminal. The upper arm switch of a first phase is referred to as a first upper arm switch, the lower arm switch of the first phase is referred to as a first lower arm switch, the upper arm switch of a second phase is referred to as a second upper arm switch, the lower arm switch of the second phase is referred to as a second lower arm switch, the upper arm switch of a third phase is referred to as a third upper arm switch, the lower arm switch of the third phase is referred to as a third lower arm switch.

The power conversion device further has first to third inductors. The first inductor electrically connects a connection point of the first upper arm switch and the first lower arm switch to a first AC terminal. The second inductor electrically connects a connection point of the second upper arm switch and the second lower arm switch to a second AC terminal. The third inductor electrically connects a connection point of the third upper arm switch and the third lower arm switch to a third AC terminal.

When 3-phase terminals of the 3-phase AC power source are connected to the first to third AC terminal respectively, the power conversion device converts AC power supplied to the first to third AC terminals to DC power and outputs the DC power through a high voltage DC terminal and a low voltage DC terminal, by switching the upper arm switches and the lower arm switches respectively.

The power conversion device may further have first to third capacitors, each of them being an X-class capacitor. The first AC terminal is electrically connected to a first terminal of the first capacitor, the second AC terminal is electrically connected to a first terminal of the second capacitor, and the third AC terminal is electrically connected to a first terminal of the third capacitor. Second terminals of the first to third capacitors are electrically connected to each other at a neutral point. The neutral point is connected to a connection point of the pair of DC capacitors. The pair of DC capacitors are connected in series and electrically connect the high voltage DC terminal and the low voltage DC terminal. This configuration can reduce common mode noise when the switching is performed.

### SUMMARY

The power conversion device of this disclosure is, a power conversion device (10) including: a first AC terminal (Tac1), a second AC terminal (Tac2), a third AC terminal (Tac3), a fourth AC terminal (Tac4), a high voltage DC terminal (TdcH), a low voltage DC terminal (TdcL), a series-connected element of a first upper arm switch (S1H) and a first lower arm switch (S1L), a series-connected element of a second upper arm switch (S2H) and a second lower arm switch (S2L), a series-connected element of a third upper arm switch (S3H) and a third lower arm switch (S3L), a series-connected element of an upper arm rectifier (S4H, D4H) and a lower arm rectifier (S4L, D4L), a first inductor (31) electrically connecting a connection point of the first upper arm switch and the first lower arm switch to the first AC terminal, a second inductor (32) electrically connecting a connection point of the second upper arm switch and the second lower arm switch to the second AC terminal, a third inductor (33) electrically connecting a connection point of the third upper arm switch and the third lower arm switch to the third AC terminal, a connection line (44) electrically connecting a connection point of the upper arm rectifier and the lower arm rectifier to the fourth AC terminal, a single-phase charge switch (45) installed in the connection line, a first capacitor (161), a second capacitor (162), a third capacitor (163), a connection switch (151), a DC connector (34A, 34B, 34), and a control unit (70). A 3-phase AC power source (21) can be connected to the first AC terminal. The second AC terminal, and the third AC terminal. A single-phase ac power source (22) can be connected to the first AC terminal and the fourth AC terminal. The high voltage terminal of each of the first upper arm switch, the second upper arm switch, and the third upper arm switch and the high voltage terminal of the upper arm rectifier are electrically connected to high voltage DC terminal. The low voltage terminal of each of the first lower arm switch, the second lower arm switch, and the third lower arm switch and the low voltage terminal of the lower arm rectifier are electrically connected to low voltage DC terminal. The first AC terminal of the first inductor is electrically connected to a first terminal of the first capacitor. The second AC terminal of the second inductor is electrically connected to a first terminal of the second capacitor. The third AC terminal of the third inductor is electrically connected to a first terminal of the third capacitor. Each of second terminals of the first capacitor, the second capacitor, and the third capacitor is electrically connected to each other. The second terminals of the first capacitor, the second capacitor, and the third capacitor are electrically connected to the DC connector via the connection switch. The DC connector is either one of: a connection point of a first DC capacitor (34A) and a second DC capacitor (34B) that are connected in series, the first DC capacitor and the second DC capacitor electrically connecting the high voltage DC terminal and the low voltage DC terminal, the high voltage DC terminal, and the low voltage DC terminal. When the control unit determines that the single-phase AC power source is connected to the first AC terminal and the fourth AC terminal, the control unit closes the single-phase charge switch, opens the connection switch, and performs switching control of the first upper arm switch and the first lower arm switch, for converting power between the first AC terminal and the fourth AC terminal and the high voltage DC terminal and the low voltage DC terminal.

### BRIEF DESCRIPTION OF THE DRAWING

The above and other objects, features and advantages of the present disclosure will become clearer with the following detailed description with reference to the accompanying drawings. The drawings are:

FIG. 1 shows the overall configuration of an on-board charging device according to a first embodiment;

FIG. 2 shows the on-board charging device to which the 3-phase AC power source is connected;

FIG. 3 shows the on-board charging device with to which the single-phase AC power source is connected;

FIG. 4 is a flowchart showing processes of charging storage batteries;

FIG. 5 shows a block diagram of a 3-phase charge control;

FIG. 6 is a timing chart showing changes in current and voltage in the 3-phase charge control;

FIG. 7 is a timing chart showing changes in current and voltage in the 3-phase charge control by a comparative example;

FIG. 8 is a block diagram of a single-phase charge control;

FIG. 9 is a timing chart showing changes in current and voltage in the single-phase charge control;

FIG. 10 is a timing chart showing an effect of reducing overcurrent by the first embodiment;

FIG. 11 is a timing chart of the case of overcurrent flow according to the comparative example;

FIG. 12 shows the overall configuration of the on-board charging device according to a second embodiment;

FIG. 13 shows the overall configuration of the on-board charging device according to a third embodiment;

FIG. 14 is a flowchart showing another process of charging storage batteries;

FIG. 15 shows the overall configuration of the on-board charging device according to the fourth embodiment;

FIG. 16 is a flowchart showing another process of charging storage batteries;

FIG. 17 is a timing chart showing the interleaved drive by the other embodiments;

FIG. 18 is a timing chart showing the switching control without the interleaved drive;

FIG. 19 shows the overall configuration of the on-board charging device according to another embodiment;

FIG. 20 shows the overall configuration of the on-board charging device according to another embodiment.

### DETAILED DESCRIPTION OF THE PREFERRED EMBODIMENTS

In addition to the 3-phase AC power source, a power conversion device applicable to a single-phase AC power source is desired.

This disclosure aims to provide a power conversion device and program that is applicable to a 3-phase AC power source or a single-phase AC power source.

The power conversion device of this disclosure is a power conversion device (10) including: a first AC terminal (Tac1), a second AC terminal (Tac2), a third AC terminal (Tac3), a fourth AC terminal (Tac4), a high voltage DC terminal (TdcH), a low voltage DC terminal (TdcL), a series-connected element of a first upper arm switch (S1H) and a first lower arm switch (S1L), a series-connected element of a second upper arm switch (S2H) and a second lower arm switch (S2L), a series-connected element of a third upper arm switch (S3H) and a third lower arm switch (S3L), a series-connected element of an upper arm rectifier (S4H, D4H) and a lower arm rectifier (S4L, D4L), a first inductor (31) electrically connecting a connection point of the first upper arm switch and the first lower arm switch to the first AC terminal, a second inductor (32) electrically connecting a connection point of the second upper arm switch and the second lower arm switch to the second AC terminal, a third inductor (33) electrically connecting a connection point of the third upper arm switch and the third lower arm switch to the third AC terminal, a connection line (44) electrically connecting a connection point of the upper arm rectifier and the lower arm rectifier to the fourth AC terminal, a single-phase charge switch (45) installed in the connection line, a first capacitor (161), a second capacitor (162), a third capacitor (163), a connection switch (151), a DC connector (34A, 34B, 34), and a control unit (70). A 3-phase AC power source (21) can be connected to the first AC terminal. A single-phase ac power source (22) can be connected to the first AC terminal and the fourth AC terminal. The high voltage terminal of each of the first upper arm switch, the second upper arm switch, and the third upper arm switch and the high voltage terminal of the upper arm rectifier are electrically connected to the high voltage DC terminal. The low voltage terminal of each of the first lower arm switch, the second lower arm switch, and the third lower arm switch and the low voltage terminal of the lower arm rectifier are electrically connected to low voltage DC terminal. The first AC terminal of the first inductor is electrically connected to a first terminal of the first capacitor. The second AC terminal of the second inductor is electrically connected to a first terminal of the second capacitor. The third AC terminal of the third inductor is electrically connected to a first terminal of the third capacitor. The second terminals of the first capacitor, the second capacitor, and the third capacitor are electrically connected together. The second terminals of the first capacitor, the second capacitor, and the third capacitor are electrically connected to the DC connector via the connection switch. The DC connector is either one of: a connection point of a first DC capacitor (34A) and a second DC capacitor (34B) that are connected in series, the first DC capacitor and the second DC capacitor electrically connecting the high voltage DC terminal and the low voltage DC terminal, the high voltage DC terminal, and the low voltage DC terminal. When the control unit determines that the single-phase AC power source is connected to the first AC terminal and the fourth AC terminal, the control unit closes the single-phase charge switch, opens the connection switch, and performs switching control of the first upper arm switch and the first lower arm switch, for converting power between the first AC terminal and the fourth AC terminal and the high voltage DC terminal and the low voltage DC terminal.

According to the present disclosure, a single-phase charging switch is provided in a connection line that electrically connects the connection point of upper arm rectifier and lower arm rectifier to the fourth AC terminal. When determining that the single-phase AC power source is connected to the first AC terminal and the fourth AC terminal, the control unit closes the single phase charging switch and performs switching control of the first upper arm switch and the first lower arm switch respectively so that power conversion is performed between the first AC terminal and the fourth AC terminal, and the high voltage DC terminal and the low voltage DC terminal. According to the present disclosure, a power conversion device applicable to a 3-phase AC power source or a single-phase AC power source is provided.

In the present disclosure, the connection switch, electrically connecting the second terminals of each of the first to third capacitors and the DC connector is opened in the switching control when the single-phase AC power source is connected. According to this configuration, an overcurrent flowing into the first to third capacitors due to the switching control can be suppressed.

With reference to the drawings, a plurality of embodiments will be described. In the plurality of embodiments, functionally and/or structurally corresponding and/or associated portions may be marked with the same reference code, or with reference codes differing by in the hundreds or greater place. For corresponding and/or associated portions, reference may be made to the description of the other embodiments.

### First Embodiment

The following is a description of a first embodiment embodying the power conversion device of the present disclosure, with reference to the drawings. The power conversion device of this embodiment is, for example, an AC-DC converter mounted to a vehicle such as an electric vehicle and operates as an on-board charging device.

The power conversion device has an AC terminal and a DC terminal. The power conversion device has a function of converting AC power supplied to the AC terminal, which is connected to an AC power source outside the vehicle, into DC power and outputting DC power through the DC terminal. The DC power output through the DC terminal is supplied to a storage battery of the vehicle. The power conversion device also has a function of converting DC power supplied to the DC terminal into AC power and outputting the AC power through the AC terminal. The power conversion device is applicable to both the 3-phase AC power source and the single-phase AC power source.

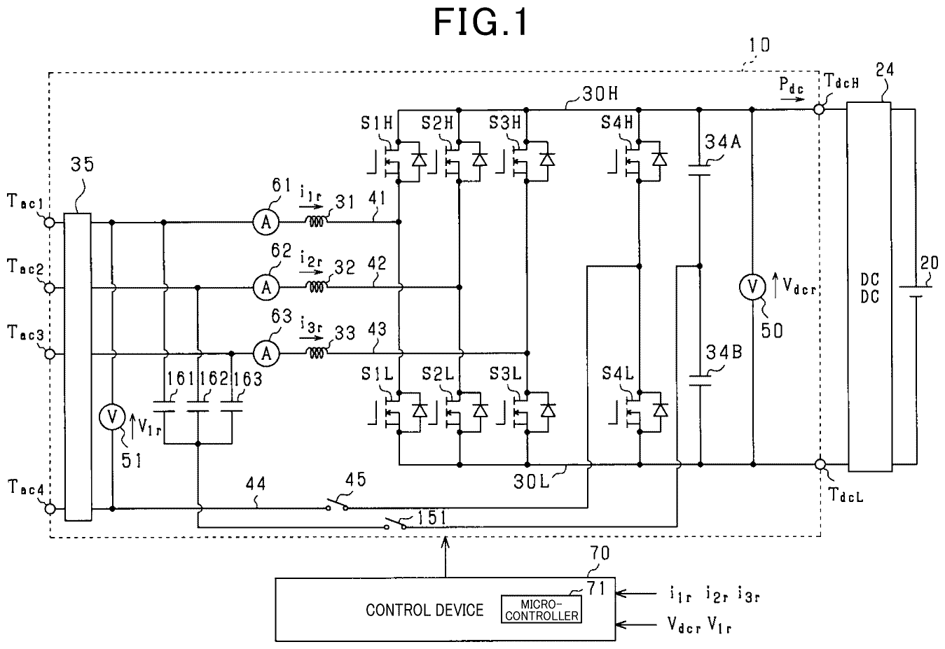

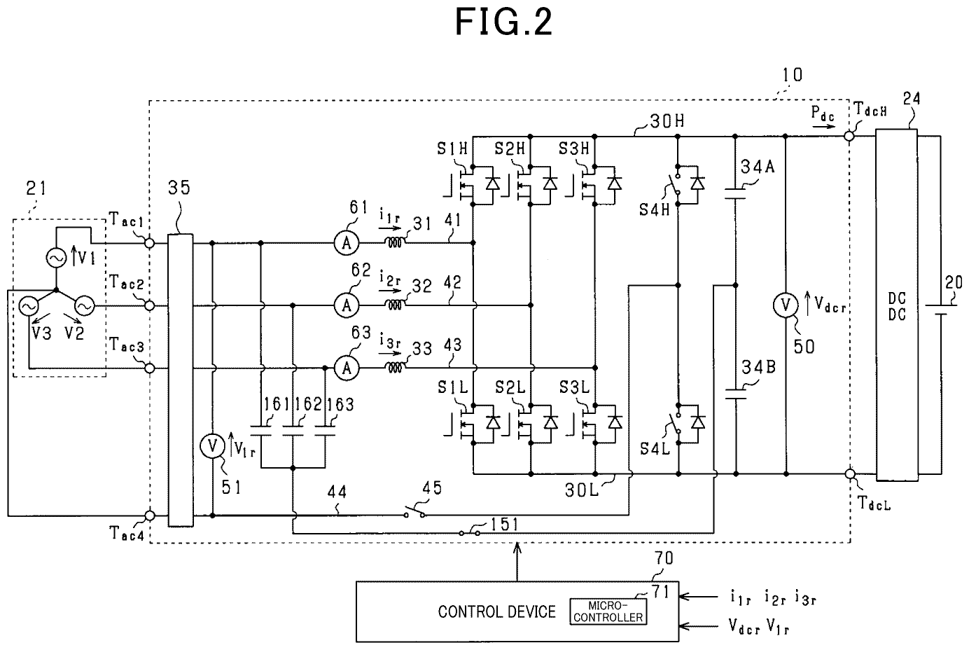

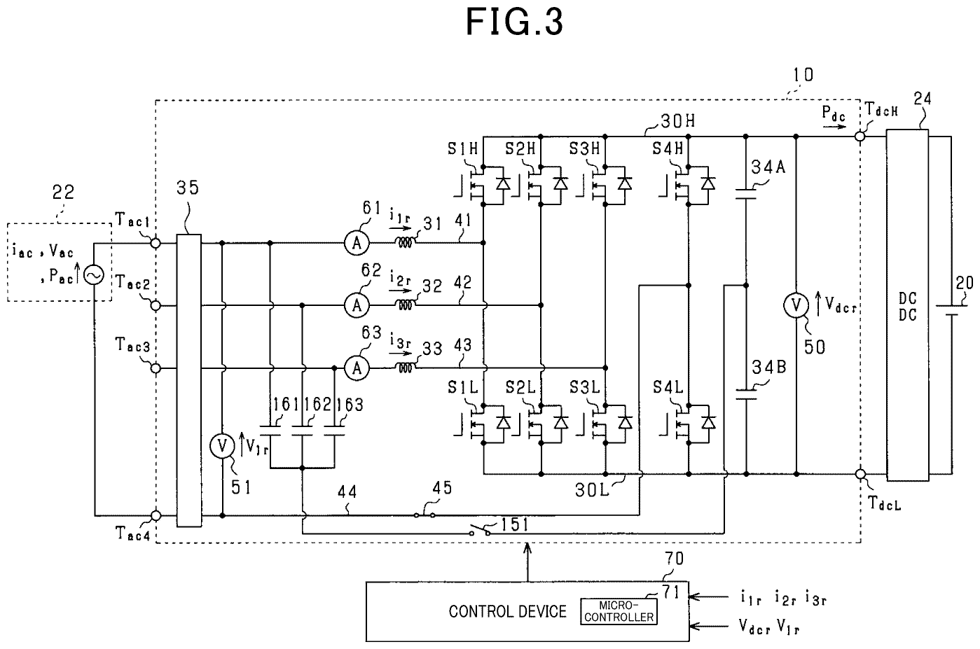

As shown in FIG. 1, the power conversion device 10 has a first AC terminal Tac1, a second AC terminal Tac2, a third AC terminal Tac3, and a fourth AC terminal Tac4, each of which is an AC terminal. As shown in FIG. 2, the first AC terminal Tac1, the second AC terminal Tac2, and the third AC terminal Tac3 can be connected to an external 3-phase AC power source 21. As shown in FIG. 3, the first AC terminal Tac1 and the fourth AC terminal Tac4 can be connected to an external single-phase AC power source 22.

The power conversion device 10 has a high voltage DC terminal TdcH and a low voltage DC terminal TdcL, each of which is a DC terminal. The high voltage DC terminal TdcH and the low voltage de terminal TdcL are connected to an input terminal of a DC-DC converter 24, which constitutes an on-board charging device. An output terminal of the DC-DC converter 24 is connected to a storage battery 20, being chargeable and dischargeable, installed in the vehicle. The DC-DC converter 24 transforms DC voltage supplied from the high voltage DC terminal TdcH and the low voltage DC terminal TdcL and supplies the transformed DC voltage to the storage battery 20. Also, the DC-DC converter 24 transforms the DC voltage supplied from the storage battery 20 and supplies it to the high voltage DC terminal TdcH and the low voltage DC terminal TdcL. The DC-DC converter 24 has a transformer connecting the input terminal and the output terminal.

The power conversion device 10 has upper arm switches and lower arm switches for 4 phases. The power conversion device 10 has a series-connected element of a first upper arm switch S1H and a first lower arm switch S1L, a series-connected element of a second upper arm switch S2H and a second lower arm switch S2L, a series-connected element of a third upper arm switch S3H and a third lower arm switch S3L, and a series-connected element of a fourth upper arm switch S4H and a fourth lower arm switch S4L. In this embodiment, each arm switch S1H to S4L is an N-channel MOSFET including a body diode. Therefore, in each arm switch S1H to S4L, a high voltage terminal is a drain, and a low voltage terminal is a source. For example, a first phase is the U phase, a second phase is the V phase, and a third phase is the W phase. The fourth upper arm switch S4H is an example of “upper arm rectifier” and the fourth lower arm switch S4L is an example of “lower arm rectifier”.

The power conversion device 10 has a high voltage line 30H. The high voltage line 30H is an electrical line connecting the respective high voltage terminals of the first upper arm switch S1H, the second upper arm switch S2H, the third upper arm switch S3H, and the fourth upper arm switch S4H to the high voltage DC terminal TdcH. The power conversion device 10 has a low voltage line 30L. The low voltage line 30L is an electrical line connecting the respective high voltage terminals of the first lower arm switch S1L, the second lower arm switch S2L, the third lower arm switch S3L, and the fourth lower arm switch S4L to the high voltage DC terminal TdcH. Each of the high voltage line 30H and the low voltage line 30L is formed by conductive members such as bus bars.

The power conversion device 10 has a series-connected element of a first DC capacitor 34A and a second DC capacitor 34B. The series-connected element connects the high voltage line 30H and the low voltage line 30L. In this embodiment, the series-connected element of the first DC capacitor 34A and the second DC capacitor 34B is an example of “DC connector”.

The power conversion device 10 has a first path 41, a second path 42, and a third path 43. The first path 41 is an electrical line, that connects the low voltage terminal of the first upper arm switch S1H and the high voltage terminal of the first lower arm switch S1L to the first AC terminal Tac1. The second path 42 is an electrical line that connects the low voltage terminal of the second upper arm switch S2H and the high voltage terminal of the second lower arm switch S2L to the second AC terminal Tac2. The third path 43 is an electrical line that connects the low voltage terminal of the third upper arm switch S3H and the high voltage terminal of the third lower arm switch S3L to the third AC terminal Tac3.

The power conversion device 10 has a first inductor 31 on the first path 41, a second inductor 32 on the second path 42, and a third inductor 33 on the third path 43. In this embodiment, each of the inductors 31 to 33 have the same specifications. Therefore, the inductance value of each of the inductors 31 to 33 are the same. The rated current (specifically, the rated current for temperature rise) of each of the inductors 31 to 33 are the same.

The power conversion device 10 has an AC filter 35. The AC filter 35 is provided closer to the AC terminal Tac1 than the inductor 31 is in the path 41, closer to the AC terminal Tac2 than the inductor 32 is in the path 42, and closer to the AC terminal Tac3 than the inductor 33 is in the path 43. The AC filter 35 may be provided, for example, to reduce common mode noise.

The power conversion device 10 has a connection line 44. The connection line 44 is an electrical line connecting the low voltage terminal of the fourth upper arm switch S4H and the high voltage terminal of the fourth lower arm switch S4L to the fourth AC terminal Tac4. The power conversion device 10 has a single-phase charge switch 45 provided on the connection line 44. The single-phase charge switch 45 permits current to flow in both directions when it is closed and prevents current flows in both directions when it is open.

The power conversion device 10 has a first capacitor 161, a second capacitor 162, and a third capacitor 163, each of which is an X-class capacitor, and a connection switch 151. A first terminal of the first capacitor 161 is connected to a portion between the first inductor 31 and the AC filter 35 in the first path 41. A first terminal of the second capacitor 162 is connected to a portion between the second inductor 32 and the AC filter 35 in the second path 42. A first terminal of the third capacitor 163 is connected to a portion between the third inductor 33 and the AC filter 35 in the third path 43. Second terminals of each of the first capacitor 161, the second capacitor 162, and the third capacitor 163 are connected to each other at a neutral point. The neutral point is connected to a connection point of the first DC capacitor 34A and the second DC capacitor 34B via the connection switch 151. The connection switch 151 permits current flows in both directions when it is closed and prevents current distribution in both flows when it is open.

The power conversion device 10 has a DC voltage sensor 50 and an AC voltage sensor 51. The DC voltage sensor 50 detects the voltage of the series-connected element of the first DC capacitor 34A and the second DC capacitor 34B. The AC voltage sensor 51 detects the voltage between the first AC terminal Tac1 and the fourth AC terminal Tac4.

The power conversion device 10 has a first current sensor 61, a second current sensor 62, and a third current sensor 63. The first current sensor 61 detects the current flowing in the first inductor 31, the second current sensor 62 detects the current flowing in the second inductor 32, and the third current sensor 63 detects the current flowing in the third inductor 33. The detected values of each sensor 50, 51, and 61 to 63 are input to the control device 70 provided by the power conversion device 10.

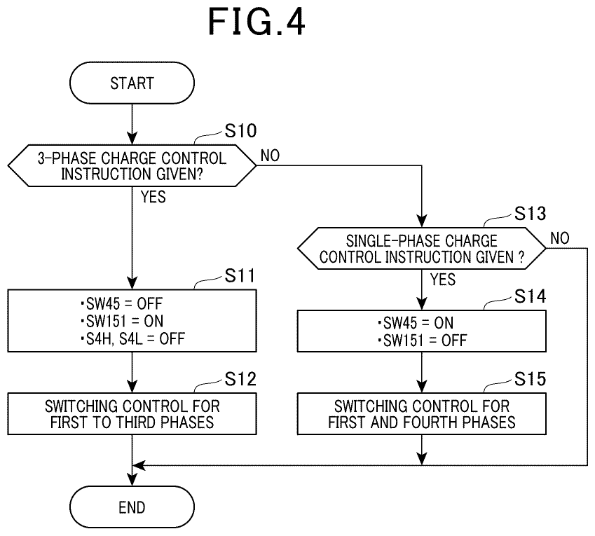

The control device (control unit) 70 is mainly composed of a microcontroller 71, which has a CPU. The functions provided by microcontroller 71 can be provided by software stored in a tangible memory device and a computer that executes it, software only, hardware only, or a combination thereof. For example, if microcontroller 71 is provided by an electronic circuit that is hardware, it can be provided by a digital or analog circuit that contains several logic circuits. For example, the microcontroller 71 may execute a program stored in its own memory, a non-transitory tangible storage medium. The program includes, for example, the programs for the processes shown in FIGS. 4, 5, 8, etc., described below. When the program is executed, the method corresponding to the program is performed. The memory is, for example, a nonvolatile memory. The program stored in the memory section can be updated via a communication network such as the Internet, for example, OTA (Over the Air).

The control device 70 performs a 3-phase charge control or a single-phase charge control. The flowchart in FIG. 4 is used below to explain the charging controls.

In step S10, the control device 70 determines whether the 3-phase charge control instruction has been given. In this embodiment, when the control device 70 determines that the 3-phase AC power source 21 is connected to the AC terminals Tac1 to Tac3 as shown in FIG. 2, the control device 70 determines that the 3-phase charge control instruction is given. In the 3-phase AC power source 21, amplitude and frequency of the output voltage of the 3-phase are the same, and the phase of the output voltage and output current are shifted by 120° in each phase. In FIG. 2, the neutral point of the 3-phase AC power source 21 is connected to the fourth ac terminal Tac4, but the neutral point of the 3-phase AC power source 21 need not be connected to the fourth AC terminal Tac4.

When a positive determination is made in step S10, the control device 70 performs the 3-phase charge control in step S11 and S12. In step S11, the control device 70 opens the single-phase charge switch 45, the fourth upper arm switch S4H and the fourth lower arm switch S4L and closes the connection switch 151.

In step S12, the control device 70, for converting AC power supplied to the first AC terminal Tac1, the second AC terminal Tac2, and the third AC terminal Tac3 to DC power and outputting DC voltage through the high voltage DC terminal TdcH and the low voltage DC terminal TdcL, performs switching control of the first upper arm switch S1H, the second upper arm switch S2H, the third upper arm switch S3H, the first lower arm switch S1L, the second lower arm switch S2L, and the third lower arm switch S3L. In each phase, the upper arm switch and the lower arm switch are alternately closed with a dead time in between. In each phase, the switching cycle of the upper arm switch and the lower arm switch are the same.

Since the connection switch 151 is closed, a ground voltage, which is a voltage between the DC terminal TdcH and the DC terminals TdcL to the neutral point (ground) of the 3-phase AC power source 21, is stabilized. As a result, common mode noise caused by stray capacitance, etc. between the high voltage line 30H and the low voltage line 30L to the ground can be reduced.

When a negative determination is made in step S10, the control device 70 proceeds to step S13 to determine whether the single-phase charge control instruction is given. In this embodiment, when the control device 70 determines that the single-phase AC power source 22 is connected to the first AC terminal Tac1 and the fourth AC terminal Tac4 as shown in FIG. 3, the control device 70 determines that the single-phase charge control instruction is given. In this case, the amplitude of the output voltage of the single-phase AC power source 22 is the same as the amplitude of the output voltage of the 3-phase AC power source 21. Also the frequency of the output voltage of the single-phase AC power source 22 is the same as the frequency of the output voltage of the 3-phase AC power source 21.

When a positive determination is made in step S13, the control device 70 performs the single-phase charge control in step S14 and S15. In step S14, the control device 70 closes the single-phase charge switch 45 and opens the connection switch 151.

In step S15, the control device 70, for converting AC power supplied to the first AC terminal Tac1 and the fourth AC terminal Tac4 to DC power and outputting the DC power through the high voltage DC terminal TdcH and the low voltage DC terminal TdcL, performs switching control of the first upper arm switch S1H and the first lower arm switch S1L. The first upper arm switch S1H and the first lower arm switch 1 are synchronously alternately closed with a dead time in between. The switching cycle of the first upper arm switch S1H and the first lower arm switch S1L are the same as that of the 3-phase charge control. The connection switch 151 is opened to suppress an overcurrent in the first 161 capacitor to the third 163 capacitor.

In step S15, the control device 70 closes the fourth lower arm switch S4L and opens the fourth upper arm switch S4H during a first period when AC current is flowing in the direction from the fourth AC terminal Tac4 to the first AC terminal Tac1 via the single-phase AC power source 22. On the other hand, the control device 70 closes the fourth upper arm switch S4H and opens the fourth lower arm switch S4L in a second period when current is flowing in the direction from the first AC terminal Tac1 to the fourth AC terminal Tac4 via the single-phase AC power source 22. The control device 70 may determine whether the current timing is included during the first period or the second period based on the detected value of the first current sensor 61, for example.

The switching cycle of the fourth upper arm switch S4H and the fourth lower arm switch S4L are the same as the cycle of the output voltage of the single-phase AC power source 22 and is longer than the switching cycle of the first upper arm switch S1H and the first lower arm switch S1L. This is because for the first phase, switching at a high frequency (e.g., tens to hundreds of kHz) is required to reduce the ripple of the current flowing in inductor 31, while for the fourth phase, switching at a frequency equivalent to the basic frequency of the output voltage of the single-phase AC power source 22 (e.g., 50 Hz or 60 Hz) is sufficient. For this reason, each of the fourth upper arm switch S4H and the fourth lower arm switch S4L is a semiconductor switching device with longer turn-on and turn-off times than each of the first upper lower arm switch S1H and the lower arm switch S1L. This allows to use lower-performance switches for the fourth upper arm switch S4H and the fourth lower arm switch S4L and reduces the cost of the power conversion device 10.

In the single-phase charge control, when DC power supplied to the DC terminal TdcH and the Dc terminal TdcL is converted to AC power and output through the AC terminal Tac1 and the AC terminal Tac4 by switching control of the first upper arm switch S1H and the first lower arm switch S1L, in step S15, the control device 70 closes the fourth upper arm switch S4H and opens the fourth lower arm switch S4L during the a period when current is flowing in the direction from the AC terminal Tac4 to the AC terminal Tac1 via the single-phase AC power source 22. On the other hand, the control device 70 closes the fourth lower arm switch S4L and opens the fourth upper arm switch S4H during a second period when current is flowing in the direction from the first AC terminal Tac1 to the fourth AC terminal Tac4 via the single-phase ac power source 22.

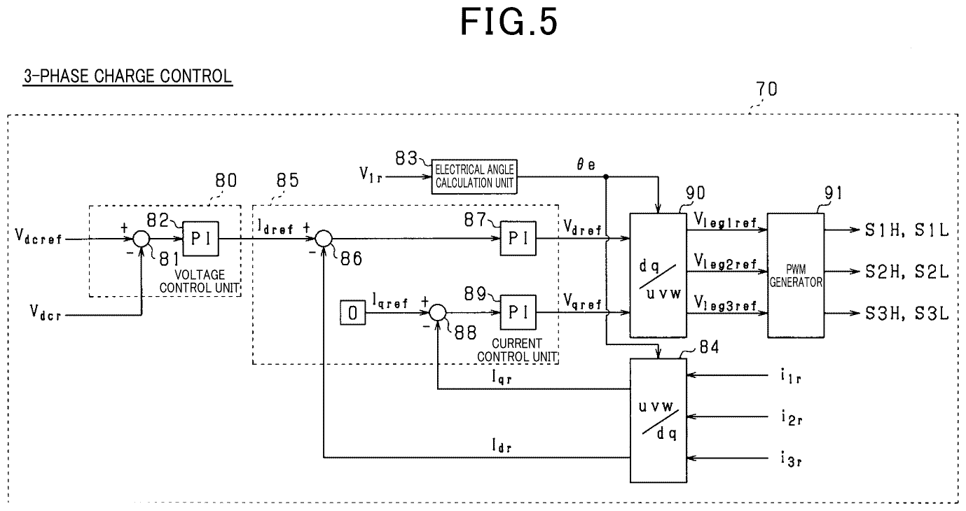

Next, an explanation of the 3-phase charge control will be given with reference to FIG. 5. FIG. 5 is a block diagram of the 3-phase charge control performed by the control device 70.

The voltage control unit 80 calculates a d-axis target current Idref to control the voltage detected by the DC voltage sensor 50 (hereinafter referred to as a detected DC voltage Vdcr) to a target DC voltage Vdcref. The voltage control unit 80 has a voltage deviation calculation unit 81 and a voltage feedback control unit 82. The voltage deviation calculation unit 81 calculates a voltage deviation ΔV by subtracting detected DC voltage Vdcr from the target DC voltage Vdcref. The target DC voltage Vdcref may be set based on the rated voltage of each upper arm switch and each lower arm switch S1H to S4L, and the DC-DC converter 24, for example.

The voltage feedback control unit 82 calculates the d-axis target current Idref, that is the operating quantity for feedback control to make the voltage deviation ΔV approach 0. The feedback control performed by the voltage feedback control unit 82 is, for example, PI control.

The electrical angle calculation unit 83 calculates an electrical angle θe based on the voltage detected by the AC voltage sensor 51 (hereinafter referred to as the AC voltage detection value Vlr). In this embodiment, the electrical angle θe at the zero-cross timing of the AC voltage detection value Vlr (specifically, for example, the zero up-cross timing) is set to 0°, and the electrical angle θe at the next zero up-cross timing is set to 360°. In this way, one cycle of the AC voltage detection value Vlr corresponds to one cycle of the electrical angle (0° to 360°). In this system, the sign of the AC voltage detection value Vlr is defined as positive for the state in which the voltage of the first AC terminal Tac1 is higher than the voltage of the fourth AC terminal Tac4.

The 2-phases conversion unit 84 converts, based on currents detected by each of the first current sensor 61, second current sensor 62, and third current sensor 63 (hereafter referred to as a first detected current i1r, a second detected current i2r, and a third detected current i3r) and the electrical angle θe, the first detected current i1r, the second detected current i2r, and the third detected current i3r into d-axis current Idr and q-axis current Iqr in the 2-phases rotating coordinate system (dq-axis coordinate system). Each of the first detected current i1r, the second detected current i2r, and the third detected current i3r is a value in the 3-phase fixed coordinate system. In this system, the sign of each of the first detected current i1r, the second detected current i2r, and the third detected current i3r is defined as positive for the state flowing from the first detected current i1r to the first inductor 31, from the second detected current i2r to the second inductor 32, and from the third detected current i3r to the third inductor 33.

The current control unit 85 has a d-axis deviation calculation unit 86, a d-axis feedback control unit 87, a q-axis deviation calculation unit 88, and a q-axis feedback control unit 89.

The d-axis deviation calculation unit 86 calculates a d-axis current deviation ΔId by subtracting d-axis current Idr from a d-axis target current Idref. The d-axis feedback control unit 87 calculates a d-axis target voltage Vdref, which is the operating quantity for feedback control to make the d-axis current deviation ΔId approach 0. The d-axis feedback control in the feedback control unit 87 is, for example, proportional-integral control.

The q-axis deviation calculation unit 88 calculates q-axis current deviation ΔIq by subtracting the q-axis current Iqr from the q-axis target current Iqref. The q-axis target current Iqref is a target value of reactive current, which in this embodiment is set to 0 to make the power factor 1. To set the power factor to 1 means to set the phase difference between each of the first output voltage V1, second output voltage V2, and third output voltage V3 of the 3-phase AC power source 21 and each of the first detected current i1r, second detected current i2r, and third detected current i3r to 0. The q-axis feedback control unit 89 performs feedback control to make the q-axis current deviation ΔIq approach 0. The feedback control performed by the q-axis feedback control unit 89 is, for example, PI control.

Based on the d-axis target voltage Vdref, the q-axis target voltage Vqref, and the electrical angle θe, the 3-phase conversion unit 90 converts the d-axis target voltage Vdref and q-axis target voltage Vqrefd in the 2-phases rotating coordinate system to a first target voltage Vleg1ref, a second target voltage Vleg2ref, and a third target voltage Vleg3ref in the 3-phase rotating coordinate system. The first target voltage Vleg1ref, the second target voltage Vleg2ref, and the third target voltage Vleg3 are offset in phase by 120° in electrical angle, and each is substantially a SIN signal. A SIN signal is a signal that is zero at every 180° electrical angle.

The PWM generator 91 generates a first upper arm drive signal, a first lower arm drive signal, a second upper arm drive signal, a second lower arm drive signal, a third upper arm drive signal, and the third lower arm drive signal based on pulse width modulation (PWM) based on a magnitude comparison of each of the first target voltage Vleg1ref, second target voltage Vleg2ref, and third target voltage Vleg3ref and the carrier signal. The first upper arm drive signal is supplied to the first upper arm switch S1H, the first lower arm drive signal is supplied to the first lower arm switch S1L, the second upper arm drive signal is supplied to the second upper arm switch S2H, the second lower arm drive signal is supplied to the second lower arm switch S2L, the third upper arm drive signal is supplied to the third upper arm switch S3H, and the third lower arm drive signal is supplied to the third lower arm switch S3L. The carrier signal may be, for example, a triangular wave signal. One cycle of the carrier signal is sufficiently shorter than one cycle of the electrical angle (0° to 360°). The switching patterns of the first upper arm switch S1H and the first lower arm switch S1L, the switching patterns of the second upper arm switch S2H and the second lower arm switch S2L, and the switching patterns of the third upper arm switch S3H and the third lower arm switch S3L are offset by 120° in phase from each other.

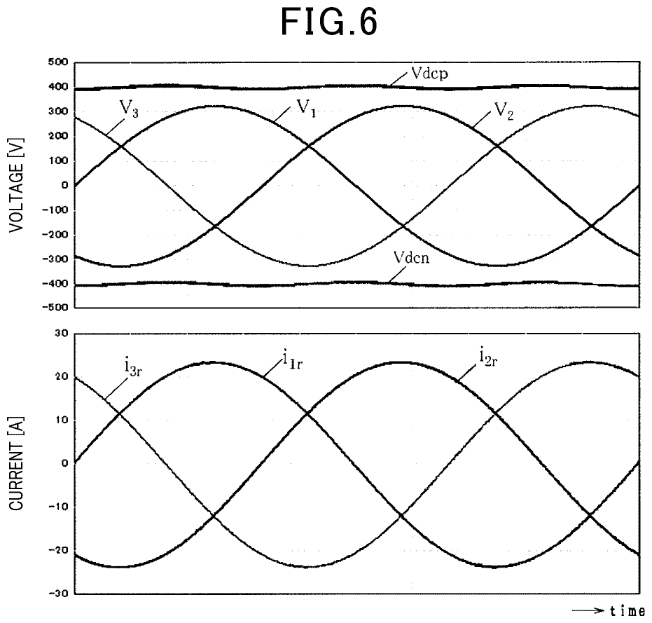

FIG. 6 shows changes of the first output voltage V1, second output voltage V2, third output voltage V3, the first detected current i1r, the second detected current i2r, the third detected current i3r, a high potential-to-ground voltage Vdcp and a low potential-to-ground voltage Vden of the 3-phase AC power source 21 when the 3-phase charge control is performed. The first output voltage V1, the second output voltage V2, and third output voltage V3 are the voltages of the first AC terminal Tac1, the second AC terminal Tac2, and the third AC terminal Tac3, respectively. Each of the first output voltage V1, the second output voltage V2, and the third output voltage V3 are defined as positive in the state where all of them are higher than the voltage at the neutral point of the 3-phase AC power source 21. The high potential-to-ground voltage Vdcp is a voltage of the high voltage DC terminal TdcH with respect to the ground voltage, and the low potential-to-ground voltage Vdcn is a voltage of the low voltage DC terminal TdcK with respect to the ground voltage.

In the example shown in FIG. 6, the frequency of the output voltages V1 to V3 of the 3-phase AC power source 21 is set to 50 Hz and the target DC voltage Vdcref is set to 800 V.

As shown in FIG. 6, 3-phase charge control is performed such that the phase difference between each of the first output voltage V1 and the first detected current i1r, the second output voltage V2 and the second detected current i2r, and the third output voltage V3 and the third detected current i3r, is 0 (i.e., the power factor is 1).

In the 3-phase charge control, each of the high potential-to-ground voltage Vdcp and the low potential-to-ground voltage Vden does not oscillate with the high switching frequency of the first upper arm switch S1H and the first lower arm switch S1L. This is because the connection point on the second terminals of the X-class capacitors, the first to third capacitors 161 to 163, function as virtual neutral points. This reduces common mode noise caused by stray capacitance, etc. between the high voltage line 30H and the low voltage line 30L to the ground, thereby enabling downsizing of the AC filter 35.

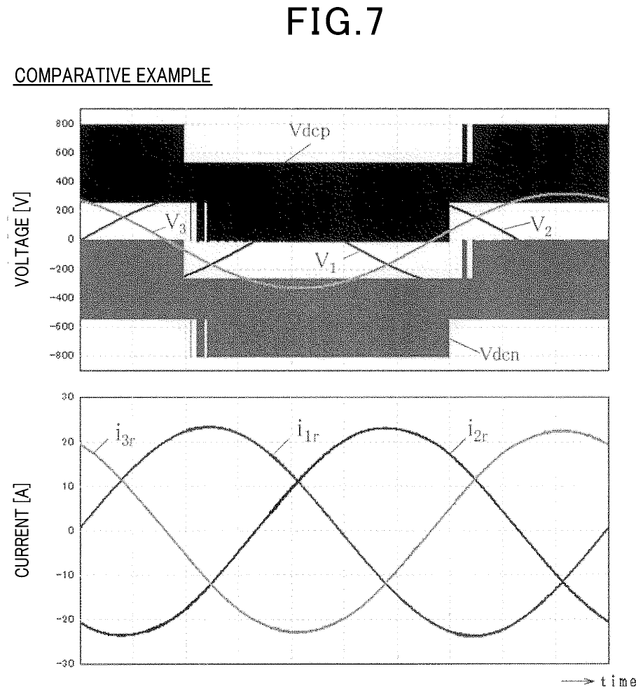

FIG. 7 shows, as a comparative example, the case where connection switch 151 is opened in the 3-phase charge control. In this case, the connection point of the second terminal of the first to third capacitors 161 to 163 and the connection point of the DC capacitor 34a and the DC capacitor 34b are electrically disconnected. Therefore, the high potential-to-ground voltage Vdcp and the low potential-to-ground voltage Vdon oscillate with the high switching frequency of the upper arm switch S1H and the lower arm switch A1L, resulting in the need for a larger AC filter 35.

The control device 70 may perform switching control of the first upper arm switch S1H and the first lower arm switch S1L based on average current mode control, etc., instead of the control shown in FIG. 5 as the 3-phase charge control.

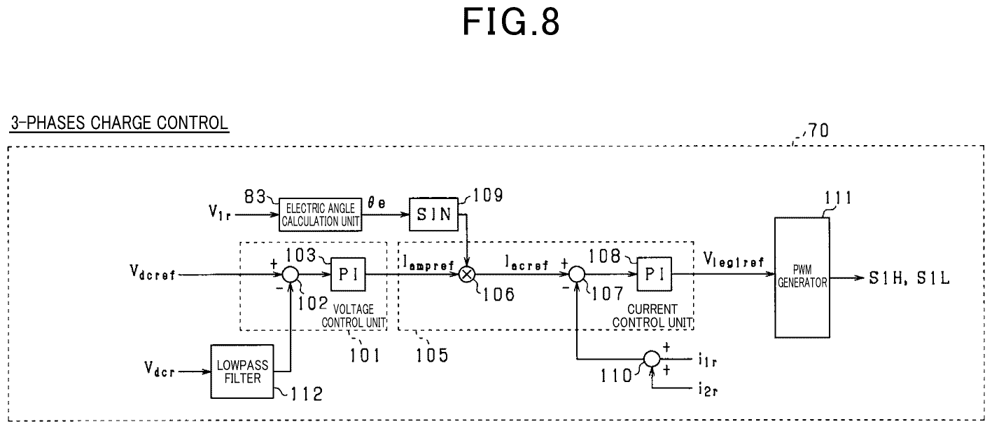

Explanations of the single-phase charge control are given with reference to FIG. 8. FIG. 8 is a block diagram of the single-phase charge control performed by the control device 70.

The filter 112 of the control device 70 performs lowpass filtering on the target DC voltage Vdcr. This process removes harmonic components of the output voltage of the single-phase AC power source 22 contained in the target DC voltage Vdcr. The harmonic components are, for example, components of the second-order frequency of the output voltage (e.g., 100 Hz or 120 Hz).

The voltage control unit 101 has a voltage deviation calculation unit 102 and a voltage feedback control unit 103. The voltage deviation calculation unit 102 calculates the voltage deviation ΔV by subtracting the detected DC voltage Vdcref from the target DC voltage Vdcr, from which the harmonic components are removed by the filter 112. The voltage feedback control unit 103 calculates the target current amplitude Iampref, which is an operating quantity for feedback control to make the voltage deviation ΔV approach 0. The feedback control performed by the voltage feedback control unit 103 is, for example, PI control.

The electrical angle calculation unit 83 calculates the electrical angle Be based on the AC voltage detection value V1r. The SIN wave generator 109 generates a SIN wave signal “SIN×θe” based on the electrical angle θe.

The current control unit 105 has a target current calculation unit 106, a current deviation calculation unit 107, and a current feedback control unit 108.

The target current calculation unit 106 calculates a target current Iacref by multiplying the target current amplitude Iampref by the sinusoidal signal “SIN×θe”. The target current Iacref fluctuates with the same period as the AC voltage detection value Vr.

The current deviation calculation unit 107 calculates a current deviation ΔI by subtracting the total value of the first detected current i1r and second detected current i2r from the target current Iacref. The total value of the first detected current i1r and second detected current i2r is calculated by the current addition unit 110.

The current feedback control unit 108 calculates a first target voltage Vleg1ref, which is an operating amount for feedback control to make the current deviation ΔI approach 0. The feedback control performed by the current feedback control unit 108 is, for example, PI control.

The PWM generator 111 generates the first upper arm drive signal and the first lower arm drive signal to be supplied to the gates of the first upper arm switch S1H and the first lower arm switch S1L, respectively, by pulse width modulation based on a large-to-small comparison between the first target voltage Vleg1ref and the carrier signal.

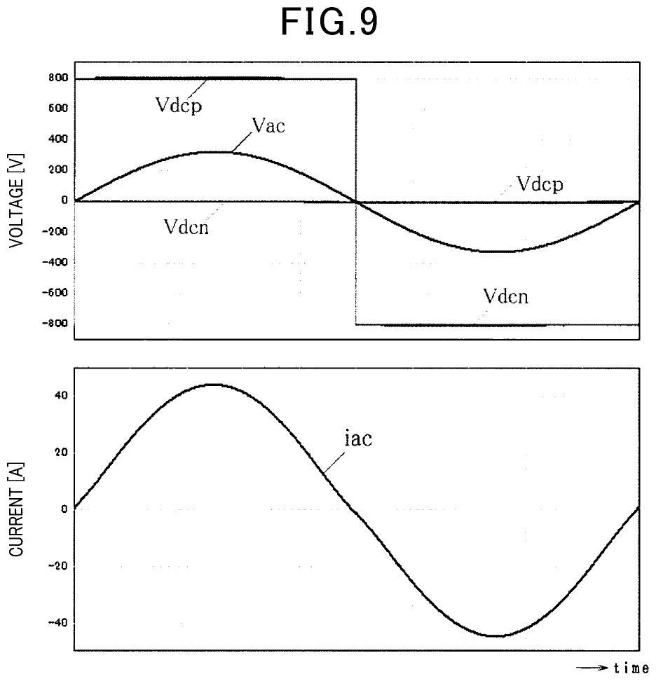

FIG. 9 shows changes of the output voltage Vac, the output current iac, the high potential-to-ground voltage Vdcp and the low potential-to-ground voltage Vden of the single-phase ac power source 22 when the single-phase charge control is performed. The output voltage vac of single-phase AC power source 22 is defined as positive for the state in which the voltage at the first AC terminal Tac1 is higher than the voltage at the fourth AC terminal Tac4. The output current iac of the single-phase AC power source 22 is defined as positive in the state where it is flowing from the fourth AC terminal Tac4 toward the first AC terminal Tac1.

In the example shown in FIG. 9, the frequency of the output voltage Vac of the single-phase AC Power source 22 is set to 50 Hz, the RMS value of the output voltage Vac is set to 230 Vrms, and the target DC voltage Vdcref is set to 800 V.

The high-frequency switching control of the first upper arm switch S1H, and the first lower arm switch S1L, and the 50 Hz switching control of the fourth upper arm switch S4H and the fourth lower arm switch S4L, are performed for the single-phase charge control such that the phase difference between the output voltage Vac and the output current iac of the single-phase AC power source 22 is zero (that is, the power factor is 1).

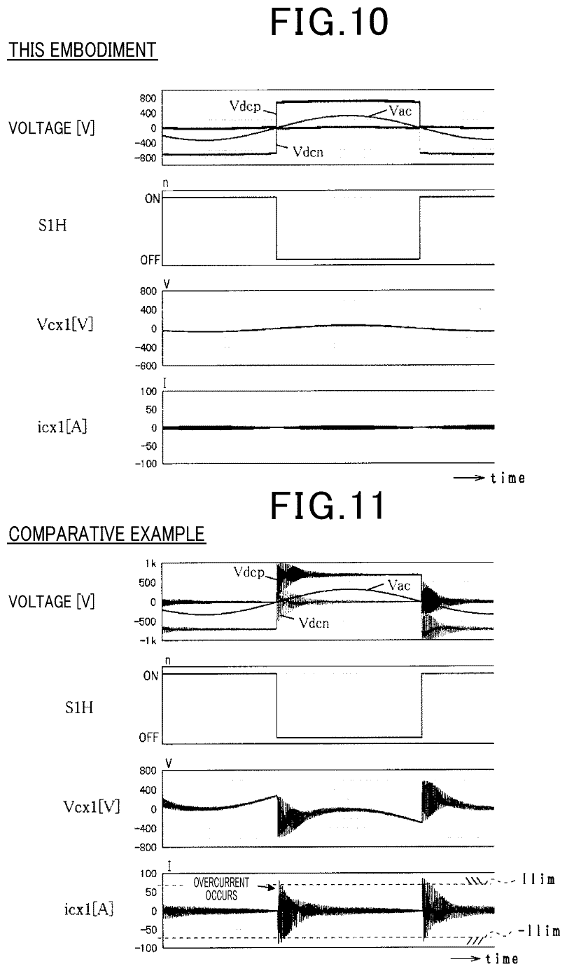

FIG. 10 shows changes of the output voltage Vac of single-phase AC power source 22, the high potential-to-ground voltage Vdcp, the low potential-to-ground voltage Vdcn, the switching state of the first upper arm switch A1H, a terminal voltage Vcx1 of the first capacitor 161, and a current icx1 flowing in the first capacitor 161 when the single-phase charge control is performed. Since the connection switch 151 is opened when the single-phase charge control is performed, no overcurrent flows through the first capacitor 161 due to the switching control of the first upper arm switch S1H and the first lower arm switch S1L in this embodiment.

FIG. 11 shows the timing chart corresponding to FIG. 10 when the comparative example performs the single-phase charge control. In the comparative example, the connection switch 151 remains closed in the single-phase charge control.

In the comparative example, each time the fourth upper arm switch S4H and the fourth lower arm switch S4L is switched, the terminal voltage of the first capacitor 161 suddenly changes, and the sudden change causes a resonance current to flow in the first capacitor 161, resulting in an overcurrent in the first capacitor 161. In the comparative example shown in FIG. 11, the current flowing in the first capacitor 161 exceeds the allowable upper limit current Ilim of the first capacitor 161.

As explained above, this embodiment reduces common mode noise in 3-phase charge control by the first to third capacitors 161 to 163, while suppressing the overcurrent in the first to third capacitors 161 to 163 when the single-phase charge control is performed.

### Second Embodiment

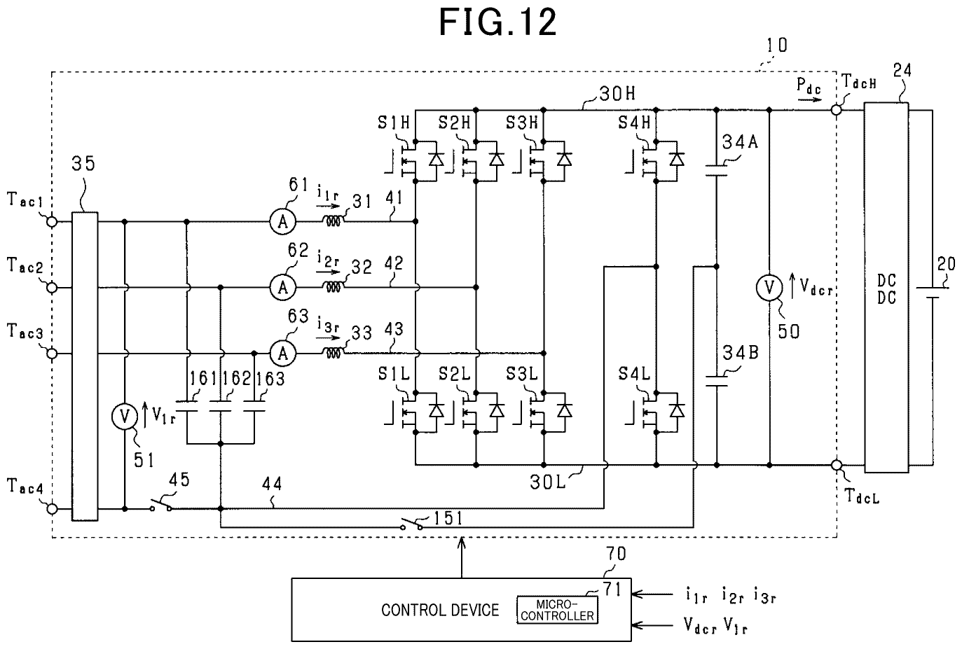

The second embodiment will be described below with reference to the drawings, focusing on the differences from the first embodiment. In this embodiment, as shown in FIG. 12, the neutral point of the first to third capacitors 161 to 163 are connected to one terminal of the connection switch 151 and a portion closer to the DC capacitor 34a and the DC capacitor 34b than the single-phase charge switch 45 in the connection line 44. This allows the first to third capacitors 161 to 163 to function as X-class capacitors when the single-phase charge control is performed and reduce the fluctuations in the high potential-to-ground voltage Vdcp and the low potential-to-ground voltage Vdcn.

The 3-phase charge control and the single-phase charge control in this embodiment respectively are the same as the control shown in FIGS. 4, 5, and 8 of the first embodiment. When the single-phase charge control is performed, the first capacitor 161 electrically connects the first path 41 to the connection point of the fourth upper arm switch S4H and the fourth lower arm switch S4L. This provides a filter effect to reduce normal mode noise and common mode noise.

On the other hand, when the 3-phase charge control is performed, since the fourth upper arm switch S4H and the fourth lower arm switch S4L are kept opened, even though the first capacitor 161 electrically connects the first path 41 to the connection point of the fourth upper arm switch S4H and the fourth lower arm switch S4L, it does not adversely affect the filter performance of the first to third capacitors 161 to 163.

According to the embodiment described above, the X-class capacitor can be shared in the 3-phase charge control and the single-phase charge control. Therefore, it is not necessary to provide a new dedicated X-class capacitor for the single-phase charge control, and the power conversion device 10 can be downsized.

### Third Embodiment

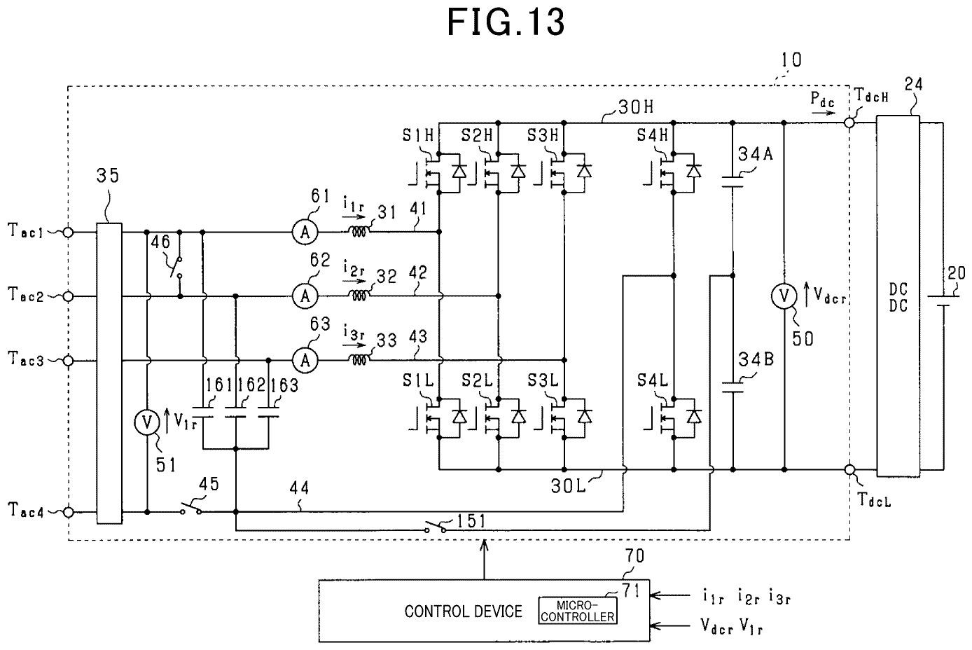

The third embodiment will be described below with reference to the drawings, focusing on the differences from the first embodiment. As shown in FIG. 13, the power conversion device 10 of the third embodiment has a second single-phase charging switch 46. The second single-phase charge switch 46 connects the portion closer to the AC terminal Tac1 than the first inductor 31 in the first path 41 and the portion closer to the AC terminal Tac2 than the second inductor 32 in the second path 42. The second single-phase charge switch 46 permits current flows in both directions when it is closed and prevents current flows in both directions when it is open. The second single-phase charge switch 46 may, for example, connect the first AC terminal Tac1 and the second AC terminal Tac2. In this embodiment, the single-phase charge switch 45 will be referred to as the first single-phase charge switch 45.

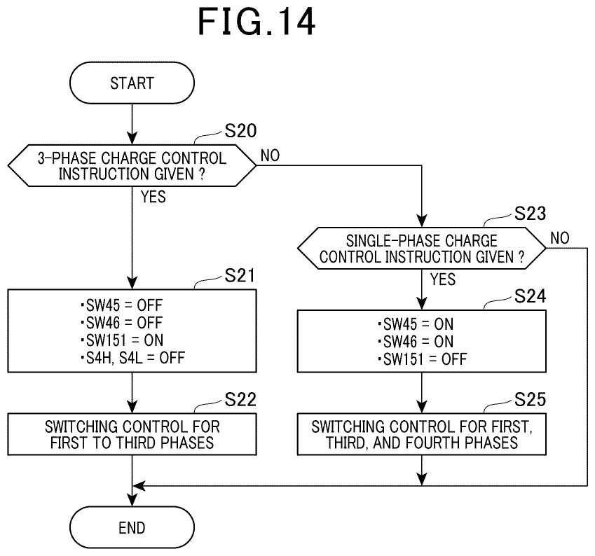

Explanations of the 3-phase charge control or the single-phase charge control performed by the control device 70 are given with reference to FIG. 14.

In step S20, the control device 70 determines whether the 3-phase charge control instruction is given, as in step S10.

When a positive determination is made in step S20, the control device 70 performs 3-phase charge control in step S21 and S22. In step s21, the control device 70 opens the first single-phase charge switch 45, the second single-phase charge switch 46, the fourth upper arm switch S4H and the fourth lower arm switch S4L, and closes connection switch 151.

In step S22, the control device 70, for converting AC power supplied to the first AC terminal Tac1, the second AC terminal Tac2, and the third AC terminal Tac3 to DC power for output through the high voltage DC terminal TdcH and the low voltage DC terminal TdcL, performs switching control of the first upper arm switch S1H, the second upper arm switch S2H, the third upper arm switch S3H, the first lower arm switch S1L, the second lower arm switch S2L, and the third lower arm switch S3L as in step S12.

When a negative determination is made in step S20, the control device 70 proceeds to step S23. In step S23, the control device 70 determines whether the single-phase charge control instruction is given, as in step S13.

When a positive determination is made in step S23, the control device 70 performs the single-phase charge control in step S24 and S25. In step S24, the control device 70 closes the first single-phase charge switch 45 and the second single-phase charge switch 46 and opens connection switch 151.

In step S25, the control device 70, for converting AC power supplied to the first AC terminal Tac1 and the fourth AC terminal Tac4 to DC power for output through the high voltage DC terminal TdcH and the low voltage DC terminal TdcL, performs switching control of the first upper arm switch S1H, the first lower arm switch S1L, the second upper arm switch S2H, and the second lower arm switch S2L. In each phase, the upper arm switch and lower arm switch are alternately closed with a dead time in between. In each phase, one switching cycle of the upper arm switch and the lower arm switch are the same as that of the 3-phase charge control.

In step S25, the control device 70 closes the fourth lower arm switch S4L and opens the fourth upper arm switch S4H during a first period when AC current is flowing in the direction from the fourth AC terminal Tac4 to the first AC terminal Tac1 via the single-phase AC power source 22. On the other hand, the control device 70 closes the fourth upper arm switch S4H and opens the fourth lower arm switch S4L during a second period when current is flowing in the direction from the first AC terminal Tac1 to the fourth AC terminal Tac4 via the single-phase AC power source 22.

According to the third embodiment described above, since the second single-phase charge switch 46 is closed when the single-phase charge control is performed, the first inductor 31 and the second inductor 32 can be used as power transfer paths. This allows DC power output through the high voltage DC terminal TdcH and the low voltage DC terminal TdcL to be increased.

According to the third embodiment, since the second capacitor 162 can also provide function as a filter when the single-phase charge control is performed, it is possible to improve the common mode noise reduction effect.

### Fourth Embodiment

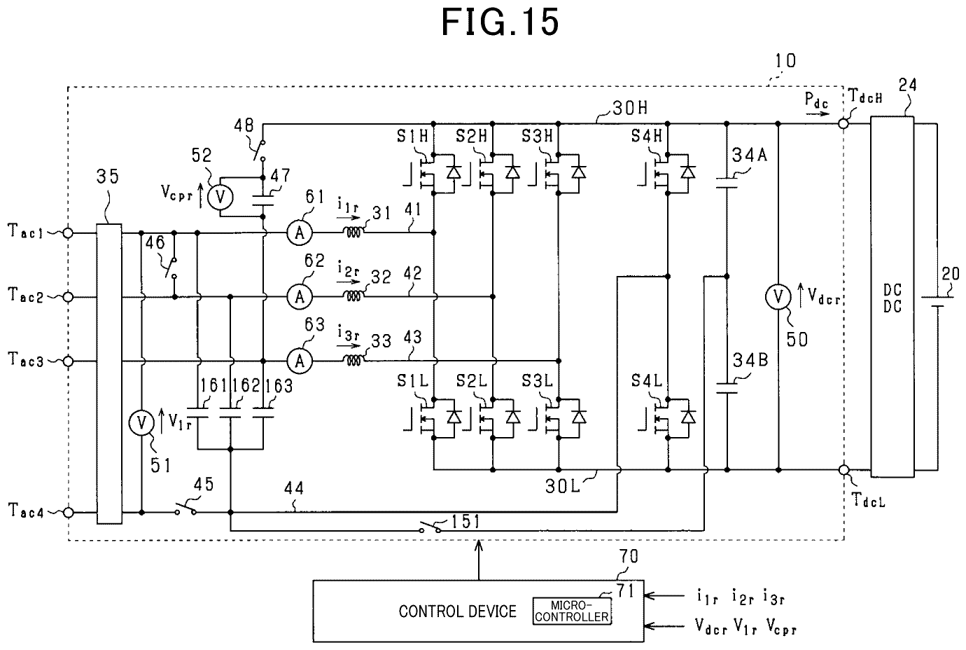

The fourth embodiment is described below with reference to the drawings, focusing on the differences from the third embodiment. In this embodiment, as shown in FIG. 15, power conversion device 10 has a series-connected element of a compensation capacitor 47 and a compensation switch 48 as a configuration for reducing pulsation of DC power output through the dc terminal TdcH and the de terminal TdcL. The series-connected element connects the high voltage line 30H and the portion of the third path 43 closer to the third AC terminal Tac3 than the third inductor 33. The compensation capacitor 47 may be, for example, a film capacitor. The compensation switch 48 permits current flows in both directions when it is closed and prevents current flows in both directions when it is open. The series-connected element of the compensation capacitor 47 and the compensation switch 48 may connect the high voltage line 30H and the third AC terminal Tac3. The compensation capacitor 47 may be positioned closer to the high voltage line 30H than the compensation switch 48.

The power conversion device 10 has a compensation voltage sensor 52. The compensation voltage sensor 52 detects the terminal voltage of the compensation capacitor 47. The detected value of voltage of the compensation capacitor 47 is input to the control device 70.

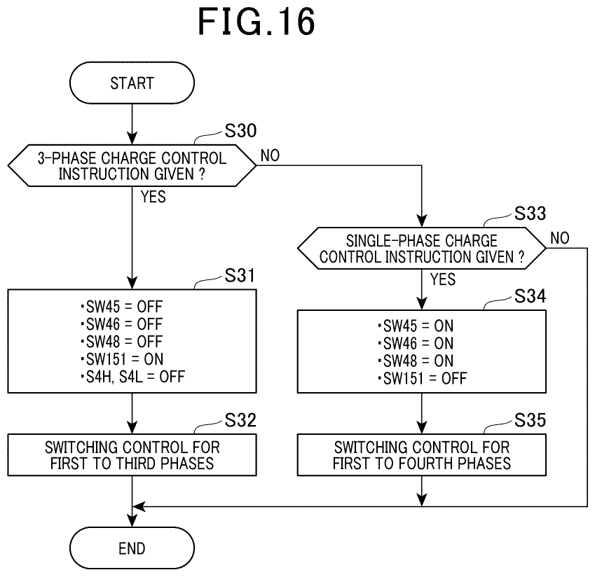

Explanations of the 3-phase charge control or the single-phase charge control performed by the control device 70 are given with reference to FIG. 16.

In step S30, the control device 70 determines whether the 3-phase charge control instruction is given, as in step S20.

When a positive determination is made in step S30, the control device 70 performs 3-phase charge control in step S31 and S32. In step s31, the control device 70 opens the first single-phase charge switch 45, the second single-phase charge switch 46, the compensation switch 48, the fourth upper arm switch S4H and the fourth lower arm switch S4L, and closes connection switch 151.

In step S32, as in step S22, the control device 70 for converting AC power supplied to AC terminal Tac1, AC terminal Tac2 and AC terminal Tac3 to DC power and output through the high voltage DC terminal TdcH and the low voltage DC terminal TdcL, performs switching control of the first upper arm switch S1H, the second upper arm switch S2H, the third upper arm switch S3H and the first lower arm switch S1L, the second lower arm switch S2L, and the third lower arm switch S3L.

When a negative determination is made in step S30, the control device 70 proceeds to step S33 and determines whether the single-phase charge control instruction is given, as in step S23.

When a positive determination is made in step S33, the control device 70 performs the single-phase charge control in step S34 and S35. In step S34, the control device 70 closes the first single-phase charge switch 45, the second single-phase charge switch 46, and the compensation switch 48, and opens the connection switch 151.

In step S35, the control device 70, for converting AC power supplied to the first AC terminal Tac1 and the fourth AC terminal Tac4 to DC power for output through the high voltage DC terminal TdcH and the low voltage DC terminal TdcL, performs switching control of the first upper arm switch S1H, the first lower arm switch S1L, the second upper arm switch S2H, and the second lower arm switch S2L. In each phase, the upper arm switch and the lower arm switch are alternately closed with a dead time in between. In each phase, one switching cycle of the upper arm switch and the lower arm switch are the same as that of the 3-phase charge control.

The control device 70, for reducing the pulsation of the DC power output through the high voltage DC terminal TdcH and the low voltage dc terminal TdcL by charging and discharging the compensation capacitor 47, performs switching control of the third upper arm switch S3H and the third lower arm switch S3L based on the detection value of the compensation voltage sensor 52. The third upper arm switch S3H and the third lower arm switch S3L are alternately closed with a dead time in between. One switching cycle of the third upper arm switch S3H and the lower arm switch S3L are the same as that of the first upper arm switch S1H, the first lower arm switch S1L the second upper arm switch S2H, and the second lower arm switch S2L.

In step S35, the control device 70, as in step s25, closes the fourth lower arm switch S4L and opens the fourth upper arm switch S4H during a first period when AC current is flowing in the direction from the fourth AC terminal Tac4 to the first AC terminal Tac1 via the single-phase AC power source 22. On the other hand, the control device 70, during a second period when current is flowing in the direction from the AC terminal Tac1 to the AC terminal tac4 via the single-phase AC power source 22, closes the fourth upper arm switch S4H and opens the fourth lower arm switch S4L.

According to the fourth embodiment detailed above, the pulsation of DC power can be reduced while increasing the DC power output from power conversion device 10 in the single-phase charge control. As a result, the capacitance of the DC capacitor 34A and the DC capacitor 34B can be reduced, and the DC capacitor 34A and the DC capacitor 34B can be made smaller.

### Another Embodiments

Each of the above embodiments may be implemented with the following modifications.

The configuration described in the third and fourth embodiments may be applied to the second embodiment.

In the configuration shown in FIG. 15 of the fourth embodiment, instead of high voltage line 30H, the low voltage line 30L may be connected to the third path 43 via the series-connected element of the compensation capacitor 47 and the compensation switch 48.

In the fourth embodiment, a small-capacity storage battery that can be charged and discharged, for example, may be provided in place of the compensation capacitor 47.

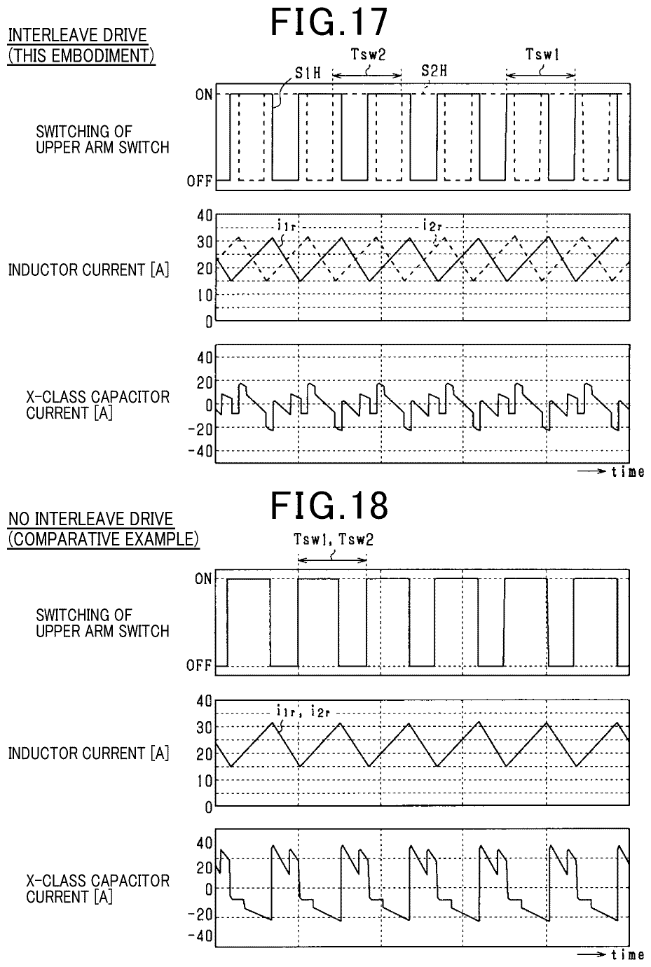

In the third and fourth embodiments, the control device 70 may interleave drive the first upper arm switch S1H, the first lower arm switch S1L, the second upper arm switch S2H, and the second lower arm switch S2L in the single-phase charge control, as shown in FIG. 17. The interleave drive is a switching control in which the switching timing of the first upper arm switch S1H to be closed and the switching timing of the second upper arm switch S2H to be closed are shifted by 180° in the electrical angle. FIG. 17 also shows the currents flowing in the first and second detected current i1r, i2r and each DC capacitor 34A, 34B in the case of interleave driving. FIG. 18 shows switching control without interleave drive as a comparative example. Tsw1 and Tsw2 in FIGS. 17 and 18 show one switching cycle for the first upper arm switch S1H and the second upper arm switch S2H.

In interleave driving, the current flowing in the first inductor 31 and the current flowing in the second inductor 32 flow in such a way that they cancel each other's current ripple. This reduces the current ripple components that flow into and out of each DC capacitor 34A, 34B, which vary with the switching frequency of the first upper arm switch S1H, the first lower arm switch S1L, the second upper arm switch S2H, and the second lower arm switch s21. As a result, the rated value of the ripple current of each DC capacitor 34A, 34B can be reduced, which in turn reduces the capacitance of each DC capacitor 34A, 34B and allows each DC capacitor 34A, 34B to be smaller.

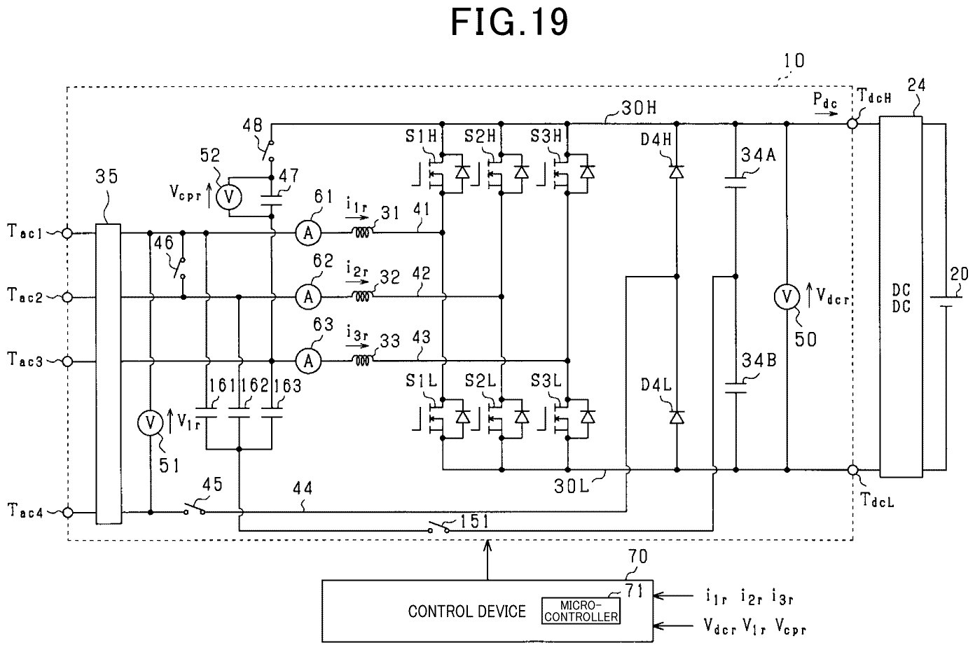

In the case of the single-phase charge control, where bi-directional power conversion is not performed and only uni-directional power conversion is performed from AC power to DC power, as shown in FIG. 19, an upper arm diode D4H and a lower arm diode D4L may be provided instead of the fourth upper arm switch S4H and the fourth lower arm switch S4L. In this case, the cathodes of the upper arm diode D4H and the lower arm diode D4L are example of “high voltage terminal” and the anodes are example of “low voltage terminal”, respectively.

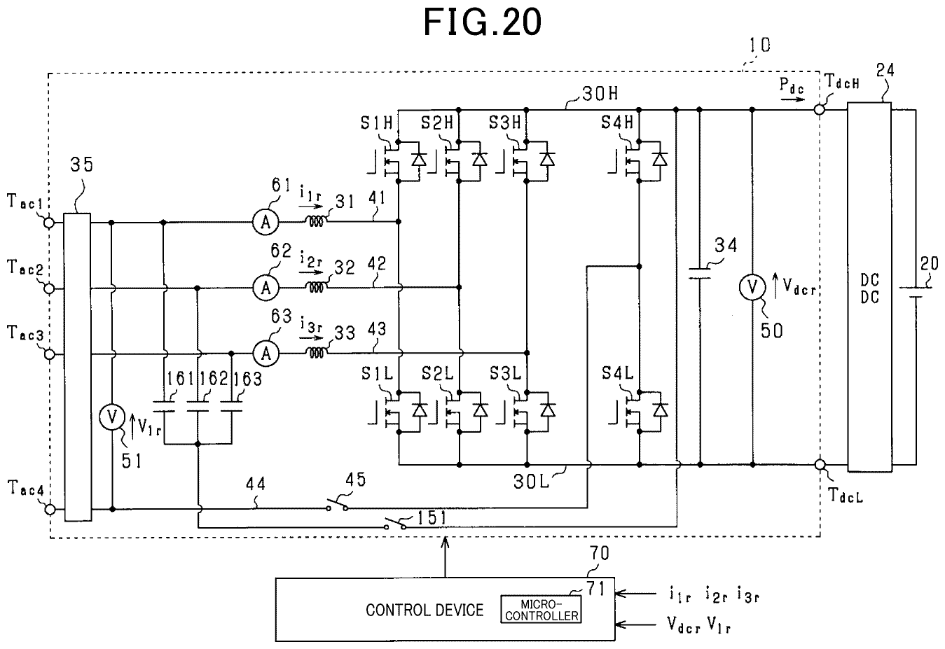

As shown in FIG. 20, the power conversion device 10 may be provided with a DC capacitor 34 instead of the series-connected element of the first DC capacitor 34A and the second DC capacitor 34B. In this case, the connection switch 151 may connect a connection point on the second terminal of the first to third capacitors 161 to 163 and high voltage line 30H. In this case, the connection switch 151 electrically connects the connection point on the second terminal of the first to third capacitors 161 to 163 and high voltage DC terminal TdcH (an example of to “DC connector”).

The connection switch 151 may also connect the connection point on the second terminal of the first to third capacitors 161 to 163 and the low voltage line 30L. In this case, the connection switch 151 electrically connects the connection point on the second terminal of the first to third capacitors 161 to 163 and the low voltage dc terminal TdcL (an example of “DC connector”).

The power conversion device 10 may have only the second function of two functions: the first function being a function of converting AC power supplied to the AC terminal from an external AC power source to DC power and output through DC terminal, and the second function being a function of converting DC power supplied to DC terminal to AC power and output from AC terminal.

The AC filter 35 may not be provided.

The first upper arm switch may include multiple N-channel MOSFETs connected in parallel. The same is true for the first lower arm switch and the second to fourth arm switches.

Each of the upper arm switch and lower arm switch is not limited to N-channel MOSFETs, but can be, for example, an IGBT with a freewheeling diode connected in reverse parallel. In this case, the collector of the IGBT corresponds to high voltage terminal and the emitter to low voltage terminal.

Instead of the first DC capacitor 34A and the second DC capacitor 34B, and the DC capacitor 34, for example, a small capacity storage battery that can be charged and discharged may be provided.

The storage unit connected to the output of DC-DC converter 24 is not limited to a storage battery, but may be, for example, a high-capacity electric double-layer capacitor or both a storage battery and an electric double-layer capacitor.

The mobile unit to which the power conversion device is mounted is not limited to vehicles, but may be, for example, an aircraft or a ship. The entity that the power conversion device is mounted to is not limited to a mobile vehicle but may also be a stationary device.

The control unit and methods described in this disclosure may be realized by a dedicated computer provided by comprising a processor and memory programmed to perform one or more functions embodied in a computer program. Alternatively, the control unit and methods described in this disclosure may be realized by a dedicated computer provided by configuring the processor with one or more dedicated hardware logic circuits. Alternatively, the control unit and its methods described in this disclosure may be realized by one or more dedicated computers provided by a combination of a processor and memory programmed to perform one or more functions and a processor configured by one or more dedicated hardware logic circuits. The computer program may also be stored in a computer-readable non-transitory recording medium as instructions to be executed by a computer.

Although this disclosure has been described in accordance with examples, it is understood that this disclosure is not limited to said examples or structures. The present disclosure also encompasses various variations and transformations within the scope of equality. In addition, various combinations and forms, as well as other combinations and forms including only one element, more or less, thereof, also fall within the scope and idea of this disclosure.

What is claimed is:

1. A power conversion device comprising:
a first AC terminal;
a second AC terminal;
a third AC terminal;
a fourth AC terminal;
a high voltage DC terminal;
a low voltage DC terminal;
a series-connected element of a first upper arm switch and a first lower arm switch;
a series-connected element of a second upper arm switch and a second lower arm switch;
a series-connected element of a third upper arm switch and a third lower arm switch;
a series-connected element of an upper arm rectifier and a lower arm rectifier;
a first inductor electrically connecting a connection point of the first upper arm switch and the first lower arm switch to the first AC terminal;
a second inductor electrically connecting a connection point of the second upper arm switch and the second lower arm switch to the second AC terminal;
a third inductor electrically connecting a connection point of the third upper arm switch and the third lower arm switch to the third AC terminal;
a connection line electrically connecting a connection point of the upper arm rectifier and the lower arm rectifier to the fourth AC terminal;
a single-phase charge switch installed in the connection line;
a first capacitor;
a second capacitor;
a third capacitor;
a connection switch;
a DC connector; and
a control unit, wherein
a 3-phase AC power source can be connected to the first AC terminal, the second AC terminal, and the third AC terminal,
a single-phase ac power source can be connected to the first AC terminal and the fourth AC terminal,
the high voltage terminal of each of the first upper arm switch, the second upper arm switch, and the third upper arm switch and the high voltage terminal of the upper arm rectifier are electrically connected to high voltage DC terminal,
the low voltage terminal of each of the first lower arm switch, the second lower arm switch, and the third lower arm switch and the low voltage terminal of the lower arm rectifier are electrically connected to low voltage DC terminal,
the first AC terminal of the first inductor is electrically connected to a first terminal of the first capacitor,
the second AC terminal of the second inductor is electrically connected to a first terminal of the second capacitor,
the third AC terminal of the third inductor is electrically connected to a first terminal of the third capacitor,
each of second terminals of the first capacitor, the second capacitor, and the third capacitor is electrically connected to each other,
the second terminals of the first capacitor, the second capacitor, and the third capacitor are electrically connected to the DC connector via the connection switch,
the DC connector is either one of: a connection point of a first DC capacitor and a second DC capacitor that are connected in series, the first DC capacitor and the second DC capacitor electrically connecting the high voltage DC terminal and the low voltage DC terminal; the high voltage DC terminal; and the low voltage DC terminal,
when the control unit determines that the single-phase AC power source is connected to the first AC terminal and the fourth AC terminal, the control unit closes the single-phase charge switch, opens the connection switch, and performs switching control of the first upper arm switch and the first lower arm switch, for converting power between the first AC terminal and the fourth AC terminal and the high voltage DC terminal and the low voltage DC terminal.

2. The power conversion device according to claim 1, wherein
the second terminals of the first capacitor, second capacitor, and the third capacitor are electrically connected to a portion of the connection line closer to the connection point of the upper arm rectifier and the lower arm rectifier than the single-phase charge switch is.

3. The power conversion device according to claim 1, wherein
the upper arm rectifier permits current flowing from the low voltage terminal of the upper arm rectifier to the high voltage terminal of the upper arm rectifier, and
the lower arm rectifier permits current flowing from the low voltage terminal of the lower arm rectifier to the high voltage terminal of the lower arm rectifier.

4. The power conversion device according to claim 3, wherein
the upper arm rectifier is a fourth upper arm switch including a diode connected in reverse parallel,
the lower arm rectifier is a fourth lower arm switch including a diode connected in reverse parallel,
when the control unit determines that the 3-phase AC power source is connected to the first AC terminal, the second AC terminal and the third AC terminal, the control unit opens the fourth upper arm switch and the fourth lower arm switch, and
when the control unit determines that the single-phase AC power source is connected to the first AC terminal and the fourth AC terminal, the control unit performs switching control to alternately close the fourth upper arm switch and the fourth lower arm switch.

5. A non-transitory computer-readable storage medium storing a program to be executed by a computer of a power conversion device, wherein
the power conversion device comprises:
a first AC terminal;
a second AC terminal;
a third AC terminal;
a fourth AC terminal;
a high voltage DC terminal;
a low voltage DC terminal;
a series-connected element of a first upper arm switch and a first lower arm switch;
a series-connected element of a second upper arm switch and a second lower arm switch;
a series-connected element of a third upper arm switch and a third lower arm switch;
a series-connected element of an upper arm rectifier and a lower arm rectifier;
a first inductor electrically connecting a connection point of the first upper arm switch and the first lower arm switch to the first AC terminal;
a second inductor electrically connecting a connection point of the second upper arm switch and the second lower arm switch to the second AC terminal;
a third inductor electrically connecting a connection point of the third upper arm switch and the third lower arm switch to the third AC terminal;
a connection line electrically connecting a connection point of the upper arm rectifier and the lower arm rectifier to the fourth AC terminal;
a single-phase charge switch installed in the connection line;
a first capacitor;
a second capacitor;
a third capacitor;
a connection switch;
a DC connector,
a 3-phase AC power source can be connected to the first AC terminal, the second AC terminal, and the third AC terminal,
a single-phase ac power source can be connected to the first AC terminal and the fourth AC terminal,
the high voltage terminal of each of the first upper arm switch, the second upper arm switch, and the third upper arm switch and the high voltage terminal of the upper arm rectifier are electrically connected to high voltage DC terminal,
the low voltage terminal of each of the first lower arm switch, the second lower arm switch, and the third lower arm switch and the low voltage terminal of the lower arm rectifier are electrically connected to low voltage DC terminal,
the first AC terminal of the first inductor is electrically connected to a first terminal of the first capacitor,
the second AC terminal of the second inductor is electrically connected to a first terminal of the second capacitor,
the third AC terminal of the third inductor is electrically connected to a first terminal of the third capacitor,
each of second terminals of the first capacitor, the second capacitor, and the third capacitor is electrically connected to each other,
the second terminals of the first capacitor, the second capacitor, and the third capacitor are electrically connected to the DC connector via the connection switch,
the DC connector is either one of: a connection point of a first DC capacitor and a second DC capacitor that are connected in series, the first DC capacitor and the second DC capacitor electrically connecting the high voltage DC terminal and the low voltage DC terminal; the high voltage DC terminal; and the low voltage DC terminal, and
the program causes the computer to:
when the computer determines that the single-phase AC power source is connected to the first AC terminal and the fourth AC terminal, close the single-phase charge switch, open the connection switch, and perform switching control of the first upper arm switch and the first lower arm switch, for converting power between the first AC terminal and the fourth AC terminal and the high voltage DC terminal and the low voltage DC terminal.
